(19) United States
(12) Patent Application Publication
(10) Pub. No.: US 2019/0351727 A1
(43) Pub. Date: Nov. 21, 2019

(54) DAMPING AIR SPRING WITH SUBSTANTIALLY FIXED VOLUME

(71) Applicant: Hendrickson USA, L.L.C., Itasca, IL (US)

(72) Inventors: Jeff R. Zawacki, Channahon, IL (US); Damon Delorenzis, Plainfield, IL (US)

(21) Appl. No.: 16/413,753

(22) Filed: May 16, 2019

Related U.S. Application Data
(60) Provisional application No. 62/673,408, filed on May 18, 2018.

(51) Int. Cl. B60G 17/048; B60G 11/27; F16F 9/04; F16F 9/05; F16F 9/58

(52) U.S. Cl. CPC B60G 17/0485; B60G 11/27; B60G 2202/152; F16F 9/052; F16F 9/585; F16F 9/049

(57) ABSTRACT

An air spring with damping characteristics for a suspension assembly of a heavy-duty vehicle includes a bellows chamber, a piston chamber, an intermediate chamber, and a first and second means for providing restricted fluid communication. The intermediate chamber is disposed at least partially within the bellows chamber and operatively connected to the bellows chamber and the piston chamber. The first means for providing restricted fluid communication is located between the bellows chamber and the intermediate chamber. The second means for providing restricted fluid communication is located between the piston chamber and the intermediate chamber. The first and second means for providing restricted fluid communication provide damping characteristics to the air spring during operation of the heavy-duty vehicle.

### CROSS-REFERENCE TO RELATED APPLICATION

This application claims the benefit of U.S. Provisional Patent Application No. 62/673,408, filed May 18, 2018.

### BACKGROUND OF THE INVENTION

### Field of the Invention

The present invention relates generally to the art of axle/suspension systems for heavy-duty vehicles. In particular, the present invention relates to axle/suspension systems for heavy-duty vehicles that utilize air springs to cushion the ride of the heavy-duty vehicle. More particularly, the present invention is directed to an air spring with damping characteristics for a heavy-duty vehicle axle/suspension system that utilizes a reduced air volume, which maintains air spring travel height and includes a bumper with an integrated flexible intermediate chamber, which is connected to the piston chamber and bellows chamber via staged openings to provide improved airflow control and promote damping of the axle/suspension system over a broad range of loads, wheel motions, and frequencies, thereby improving ride quality during heavy-duty vehicle operations.

### Background Art

The use of air-ride axle/suspension systems has been very popular in the heavy-duty vehicle industry for many years. For the purposes of clarity and convenience, reference is made to a heavy-duty vehicle with the understanding that such reference includes trucks, tractor-trailers or semi-trailers, trailers, and the like. Although air-ride axle/suspension systems can be found in widely varying structural forms, their structure is generally similar in that each system typically includes a pair of suspension assemblies. The suspension assemblies are typically connected directly to a primary frame of the heavy-duty vehicle or a subframe supported by the primary frame. For those heavy-duty vehicles that support a subframe, the subframe can be non-movable or movable, the latter being commonly referred to as a slider box, slider subframe, slider undercarriage, secondary slider frame, or bogey.

Typically, each suspension assembly of an air-ride rigid beam-type axle/suspension system includes a pair of longitudinally extending elongated beams. Each beam is typically located adjacent to and below a respective one of a pair of spaced-apart longitudinally extending main members and one or more cross members, which form the frame of the heavy-duty vehicle. For the purpose of convenience and clarity, reference herein will be made to main members with the understanding that such reference is by way of example and includes main members of primary frames, movable subframes, and non-movable subframes. Each beam is pivotally connected at one end to a hanger, which, in turn, is attached to and depends from a respective one of the main members of the heavy-duty vehicle. The beam may extend rearwardly or frontwardly from the pivotal connection relative to the front of the heavy-duty vehicle, thus defining what are typically referred to as trailing-arm or leading-arm axle/suspension systems, respectively. For the purposes of the description contained herein, it is understood that the term trailing-arm will encompass beams that extend either rearwardly or frontwardly with respect to the front of the vehicle. An axle extends transversely between, and typically is connected by some means to, the beams of the pair of suspension assemblies at a selected location from about the mid-point of the beam to the end of the beam opposite the pivotal connection end. The beam end opposite the pivotal connection end is also connected to an air spring, or its equivalent, which, in turn, is connected to a respective one of the main members. A brake system and, optionally, one or more shock absorbers for providing damping to the axle/suspension system of the vehicle also are mounted on the axle/suspension system.

The axle/suspension system acts to cushion the ride, dampen vibrations, and stabilize the heavy-duty vehicle. More particularly, as the heavy-duty vehicle travels over the road, the wheels encounter road conditions that impart various forces, loads, and/or stresses, collectively referred to herein as forces, to the respective axle on which the wheels are mounted, and, in turn, to the suspension assemblies that are connected to and support the axle. These forces include vertical forces caused by vertical movement of the wheels as they encounter certain road conditions, fore-aft forces caused by certain road conditions and by acceleration and deceleration of the heavy-duty vehicle, and side-load and torsional forces associated with transverse movement of the heavy-duty vehicle, such as turning and lane-change maneuvers.

In order to minimize the detrimental effect of these forces on the heavy-duty vehicle during operation, the axle/suspension system is designed with structural characteristics to react and/or absorb at least some of the forces. More particularly, it is desirable for an axle/suspension system to have beams that are fairly stiff in order to minimize the amount of sway experienced by the heavy-duty vehicle and provide roll stability, as is known. However, it is also desirable for an axle/suspension system to be relatively flexible to cushion the heavy-duty vehicle from impacts and provide the axle/suspension system with compliance to resist failure and increase durability. Moreover, it is desirable to damp the vibrations or oscillations that result from these forces.

A key component of the axle/suspension system that cushions the ride of the heavy-duty vehicle from vertical impacts is the air spring. Conventional air springs utilized in heavy-duty air-ride axle/suspension systems are typically characterized as either non-damping or damping. A non-damping air spring typically includes three main components: a flexible bellows, a piston, and a bellows top plate. The bellows is formed from rubber or other flexible material, and is operatively mounted on top of the piston. The piston is typically formed from steel, aluminum, fiber reinforced plastics, or other suitably rigid materials, and is mounted by fasteners on the top plate of a respective one of the beams of the suspension assembly of the axle/suspension system, as is known. The air spring bellows is filled with a volume of pressurized air provided to the air spring via an air tank or air reservoir operatively connected to the air spring and attached to the heavy-duty vehicle. The volume of pressurized air, or “air volume”, that is contained within the air spring is a major factor in determining the spring rate, or stiffness, of the air spring. The greater the air volume of the air spring, the lower the spring rate, or stiffness, of the air spring. During normal heavy-duty vehicle operations on city roads, or off-highway, a lower spring rate, or reduced stiffness, is generally more desirable because it provides a softer ride to the heavy-duty vehicle.

Prior art non-damping air springs, while providing cushioning to the cargo and occupant(s) during heavy-duty vehicle operation, provide little or no damping to the axle/suspension system. Such damping characteristics are, instead, typically provided by one or more hydraulic shock absorbers. The shock absorbers are generally configured to provide damping optimized for operation of the heavy-duty vehicle at a ride height at which the bellows volume of the air spring provides a specific spring rate, or stiffness, as is known. The shock absorbers are mounted on and extend between the beam of a respective one of the suspension assemblies and a respective one of the main members of the heavy-duty vehicle. Although shock absorbers provide damping to the axle/suspension system, they undesirably add complexity and weight to the axle/suspension system. Moreover, the shock absorbers are a service item of the axle/suspension system that require maintenance and/or replacement from time to time, adding additional maintenance and/or replacement costs to the axle/suspension system.

In order to eliminate the need for shock absorbers to provide damping to the heavy-duty vehicle axle/suspension system, air springs with damping characteristics, or damping air springs, such as the one shown and described in U.S. Pat. No. 8,540,222, and assigned to the Applicant of the instant application, Hendrickson USA, L.L.C., have been utilized. A damping air spring is typically similar in structure to a non-damping air spring, except that the damping air spring includes a piston chamber incorporating a volume of air that is in fluid communication with the bellows via at least one opening formed in the piston and providing restricted communication of air between the piston chamber and the bellows chamber during operation of the axle/suspension system.

The restricted communication of air between the piston chamber and the bellows during heavy-duty vehicle operation provides damping to the axle/suspension system. More specifically, when the axle/suspension system experiences a jounce event, such as when the heavy-duty vehicle wheels encounter a curb or raised bump in the road, the axle moves vertically upwardly toward the chassis. In such a jounce event, the air spring bellows is compressed by the axle/suspension system as the wheels of the heavy-duty vehicle travel over the curb or the raised bump in the road. The compression of the air spring bellows causes the internal pressure of the bellows to increase. Because the bellows is in fluid communication with the piston chamber via the opening(s), a pressure differential is created between the bellows and the piston chamber. This pressure differential causes air to flow from the bellows through the opening(s) into the piston chamber. Air will continue to flow back and forth through the opening(s) between the bellows and the piston chamber until the pressures of the piston chamber and the bellows have equalized. The restricted flow of air back and forth through the opening(s) causes damping to occur.

Conversely, when the axle/suspension system experiences a rebound event, such as when the heavy-duty vehicle wheels encounter a large hole or depression in the road, the axle moves vertically downwardly away from the chassis. In such a rebound event, the bellows is expanded, or pulled downwardly, by the axle/suspension system as the wheels of the heavy-duty vehicle travel into the hole or depression in the road. The expansion of the air spring bellows causes the internal pressure of the bellows to decrease, creating a pressure differential between the bellows and the piston chamber. This pressure differential causes air to flow from the piston chamber through the opening(s) into the bellows. Air will continue to flow back and forth through the opening(s) between the bellows and the piston chamber until the pressures of the piston chamber and the bellows have equalized. The restricted flow of air back and forth through the opening(s) causes damping to occur.

Prior art air springs with damping characteristics, while satisfactory for their intended purpose, have certain potential disadvantages, drawbacks, and limitations. For example, because the prior art air springs only include openings located between the bellows chamber and the piston chamber, the damping range of the air spring is typically limited to a particular load or wheel motion. These limitations on the damping range of the air spring restrict the ability to “tune” the damping for a given application. As a result, prior art air springs typically provide tunability over a relatively narrow frequency band, for instance in the range of the sprung-mass natural frequency.

In addition, prior art damping air springs typically require a large air volume, which undesirably increases the amount of space required by the axle/suspension system to accommodate prior art damping air springs, thereby increasing the weight of the axle/suspension system and reducing the space available in the heavy-duty vehicle for payload. In particular, prior art damping air springs typically include a separate or discrete internal bumper within the bellows chamber to prevent the bellows top plate from contacting the piston top plate during air loss or extreme jounce events. While the discrete internal bumper prevents damage to the air spring, the bumper is an additional part that increases the weight of the air spring, thereby increasing the weight of the axle/suspension system. Moreover, the discrete internal bumper takes up volume inside the bellows chamber of the prior art air springs. Because the spring rate of the air spring is determined by the volume of air contained in the air spring and because the discrete bumper takes up some volume of space inside the air spring, the prior art air spring with discrete bumper must be larger than an air spring that does not contain the discrete internal bumper, thus undesirably increasing the size of the air spring.

Therefore, it is desirable to have an air spring with damping features that provides tunability over a broader range of frequencies that allows the air spring to have an improved damping range over a broader range of loads and wheel motions, an expanded operating range, a reduced number of parts, and a smaller air volume, such that the air spring weighs less and requires a reduced amount of space in the axle/suspension system, thereby increasing heavy-duty vehicle payload capability and reducing the cost of material, manufacturing, and repair.

The air spring with damping features for heavy-duty vehicles of the present invention overcomes the disadvantages, drawbacks, and limitations associated with prior art air springs, with and without damping features, by providing a flexible intermediate chamber that serves as a bumper and is capable of collapse during extreme compression of the air spring during operation of the vehicle. The flexible intermediate chamber maintains a substantially fixed or constant volume during normal operation when there are no extreme jounce events acting on the air spring. Because the flexible intermediate chamber is in fluid communication with the bellows chamber and the piston chamber through staged openings, the air spring exhibits optimized damping characteristics while maintaining desired air spring travel height. The air spring for heavy-duty vehicles of the present invention provides damping features to the axle/suspension system over a broader damping range, reducing or eliminating frequency dependence, thereby accommodating a broader range of loads and wheel motions, which reduces the constraints on the operating range of the air spring. Moreover, the air spring with damping features for heavy-duty vehicles of the present invention reduces the need for larger air volumes in order to increase damping characteristics, thereby reducing the amount of space required by the axle/suspension system and providing more room for heavier payload, or cargo.

### SUMMARY OF THE INVENTION

Objectives of the present invention include providing an air spring with damping features over a broader damping range, reducing frequency dependence, such that the air spring accommodates a broader range of loads and wheel motions to reduce the constraints on the air spring operating range.

Another objective of the present invention is to provide an air spring with damping features that utilizes fewer parts with a smaller air volume, so that the air spring weighs less, thereby reducing the cost of material, manufacturing, and repair.

A further objective of the present invention is to provide an air spring with damping features that reduces the need for larger air volumes to increase damping characteristics, thereby reducing the space required for the air spring in the axle/suspension system and providing increased space for heavier payload or cargo.

Yet another objective of the present invention is to provide an air spring with damping features that has improved damping while maintaining the desired air spring travel height.

These objectives and advantages are obtained by the air spring with damping characteristics for a suspension assembly of a heavy-duty vehicle of the present invention, which includes a bellows chamber, a piston chamber, an intermediate chamber, and a first and second means for providing restricted fluid communication. The intermediate chamber is disposed within the bellows chamber and operatively connected to the bellows chamber and the piston chamber. The first means for providing restricted fluid communication is between the bellows chamber and the intermediate chamber. The second means for providing restricted fluid communication is between the piston chamber and the intermediate chamber. The first and second means for providing restricted fluid communication provide damping characteristics to the air spring during operation of the heavy-duty vehicle.

### BRIEF DESCRIPTION OF THE SEVERAL VIEWS OF THE DRAWINGS

The preferred embodiments of the present invention, illustrative of the best mode in which applicant has contemplated applying the principles, are set forth in the following description and shown in the drawings and are particularly and distinctly pointed out and set forth in the appended claims.

FIG. 1 is a rear driver-side perspective view of an axle/suspension system utilizing a pair of prior art air springs;

FIG. 2 is a perspective view, in section, of a prior art air spring with damping characteristics, showing the bellows chamber in communication with the piston chamber via a pair of openings, and a discrete bumper disposed within the bellows chamber;

FIG. 3 is an elevational view, in section, of another prior art air spring with damping characteristics, showing a discrete bumper disposed within the bellows chamber and showing a discrete intermediate chamber disposed within the piston of the air spring in fluid communication with the bellows chamber and piston chamber;

FIG. 4 is an elevational view, in section, of a first exemplary embodiment air spring of the present invention, showing the intermediate chamber acting as the bumper disposed within the bellows chamber of the air spring and in fluid communication with the bellows chamber and the piston chamber via pairs of openings;

FIG. 4A is an elevational view, in section, of the first exemplary embodiment air spring of the present invention shown in FIG. 4, showing the air spring in a compressed state;

FIG. 4B is an elevational view, in section, of an alternative configuration of the first exemplary embodiment air spring of the present invention shown in FIG. 4;

FIG. 5 is an elevational view, in section, of a second exemplary embodiment air spring of the present invention, showing the intermediate chamber acting as the bumper disposed within the bellows chamber of the air spring and in fluid communication with the bellows chamber and the piston chamber via pairs of openings, the sidewall of the intermediate chamber being continuous with the air spring bellows; and

FIG. 5A is an elevational view, in section of the second exemplary embodiment air spring shown in FIG. 5, showing the air spring in a compressed state.

Similar reference characters refer to similar parts throughout.

### DESCRIPTION OF THE PREFERRED EMBODIMENT

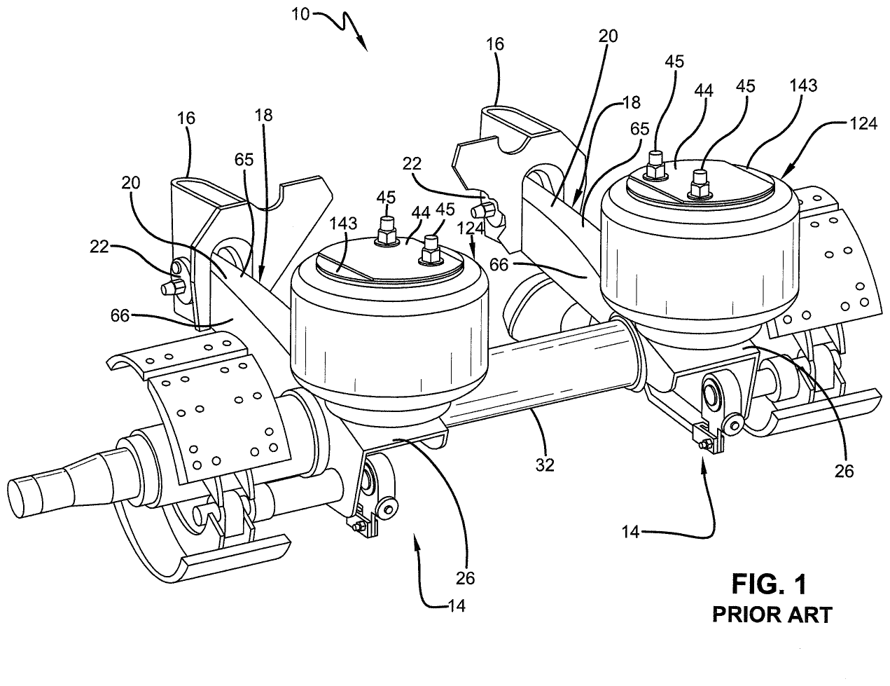

In order to better understand the environment in which the damping air spring for a heavy-duty vehicle of the present invention is utilized, a beam-type air-ride axle/suspension system 10 incorporating a prior art damping air spring 124 is shown in FIG. 1 and will be described in detail below.

It should be noted that axle/suspension system 10 typically includes a pair of mirror image suspension assemblies 14, each suspended from a respective longitudinally-extending transversely spaced-apart main member (not shown) of a heavy-duty vehicle (not shown). Because suspension assemblies 14 are mirror images and for the purposes of clarity and conciseness, only one of the suspension assemblies will be described below.

Suspension assembly 14 includes a beam 18 pivotally connected to a hanger 16, which is mounted on the main member of the heavy-duty vehicle. More specifically, beam 18 is generally formed having an upside-down integrally-formed U-shape with a pair of sidewalls 66 and a top plate 65, with the open portion of the beam facing generally downwardly. A bottom plate (not shown) extends between and is attached to the lowermost ends of sidewalls 66 by any suitable means, such as welds, to complete the structure of beam 18. Beam 18 includes a front end 20 having a bushing assembly 22 to facilitate pivotal connection of the beam to hanger 16, as is known. An axle 32 extends between and is captured by beam 18. Suspension assembly 14 also includes air spring 124, which is mounted on and extends between a beam rear end 26 and the main member of the heavy-duty vehicle.

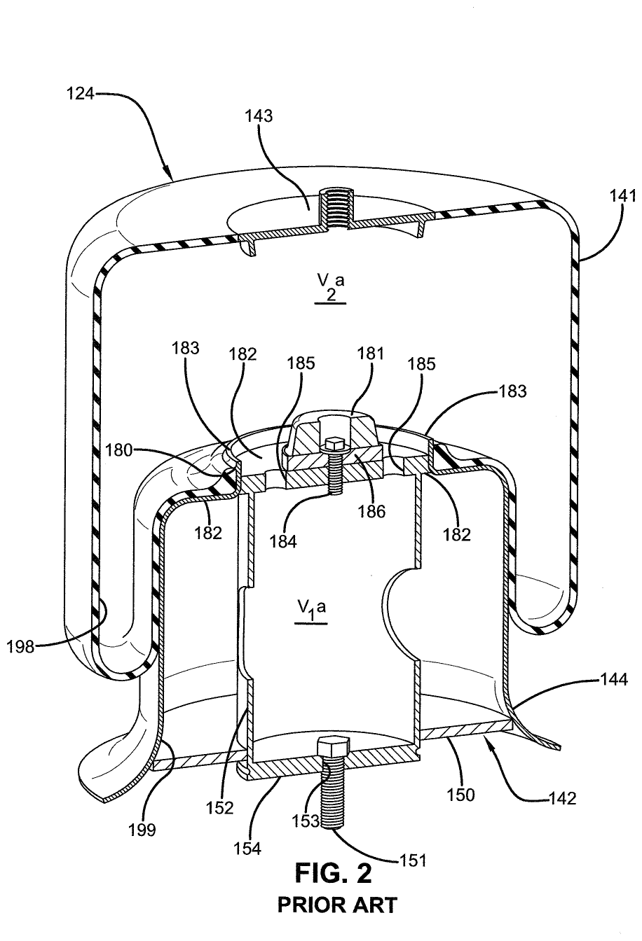

With additional reference to FIG. 2, air spring 124 includes a bellows 141 and a piston 142. The top end of bellows 141 is sealingly engaged with a bellows top plate 143, as is known. An air spring mounting plate 44 (FIG. 1) is mounted on the top surface of top plate 143 by fasteners 45, which are also used to mount the top portion of air spring 124 to a respective one of the main members of the heavy-duty vehicle. Alternatively, bellows top plate 143 could be mounted directly on a respective one of the main members of the heavy-duty vehicle, as is known. Piston 142 is generally cylindrical-shaped and includes a continuous generally stepped sidewall 144 attached to a generally flat bottom plate 150 and an integrally formed top plate 182. Top plate 182 includes a central disc or plug and a support area that extends radially outward from the central disc. Bottom plate 150 is formed with an upwardly extending central hub 152. Central hub 152 includes a bottom plate 154 formed with a central opening 153. A fastener 151 is disposed through opening 153 in order to attach piston 142 to beam top plate 65 at beam rear end 26. Bottom plate 150, sidewall 144, and top plate 182 of piston 142 define a piston chamber 199 having an internal volume V₁a at standard static or design ride height.

Top plate 182 of piston 142 is formed with a circular upwardly extending protrusion 183 having a lip 180 formed about its circumference. Lip 180 cooperates with the lowermost end of bellows 141 to form an airtight seal between the bellows and the lip, as is known. Bellows 141, top plate 143, and piston top plate 182 define a bellows chamber 198 having an internal volume V₂a at standard static or design ride height. For a heavy-duty vehicle having a gross axle weight rating (GAWR) of about 20,000 lbs., piston chamber volume V₁a and bellows chamber volume V₂a are typically about 240 in.³ and about 485 in.³, respectively. Top plate 182 is formed with a pair of circular-shaped openings 185, which allow piston chamber volume V₁a and bellows chamber volume V₂a to communicate with one another. More particularly, openings 185 allow fluid or air to pass between piston chamber 199 and bellows chamber 198 during operation of the heavy-duty vehicle. For a heavy-duty vehicle having a GAWR of about 20,000 lbs., openings 185 typically have a combined cross-sectional area of about 0.06 in.². The ratio of the cross-sectional area of openings 185 measured in square inches to the volume of piston chamber 199 measured in cubic inches to the volume of bellows chamber 198 measured in cubic inches is in the range of ratios of from about 1:600:1200 to about 1:14100:23500.

A bumper mounting plate 186 is mounted on piston top plate 182 by a fastener 184. A bumper 181 is rigidly attached to bumper mounting plate 186 in a well-known manner. Bumper 181 extends upwardly from the top surface of bumper mounting plate 186. Bumper 181 serves as a cushion to prevent contact between piston top plate 182 and bellows top plate 143, which can potentially cause damage to the plates and air spring 124 during air loss or extreme jounce events during operation of the heavy-duty vehicle.

Axle/suspension system 10 is designed to react and/or absorb forces that act on the heavy-duty vehicle during operation. More particularly, it is desirable for axle/suspension system 10 to be rigid or stiff in order to resist roll forces and thus provide the heavy-duty vehicle with roll stability. This is typically accomplished by utilizing beam 18, which is rigid and also rigidly attached to axle 32. However, it is also desirable for axle/suspension system 10 to be flexible to assist in cushioning the heavy-duty vehicle from vertical impacts and to provide the axle/suspension system with compliance to resist failure. Such flexibility is typically achieved through the pivotal connection of beam 18 to hanger 16 with bushing assembly 22. Moreover, air spring 124 cushions and controls the ride for cargo and passengers. In particular, piston chamber volume V₁a, bellows chamber volume V₂a, and the cross-sectional area of openings 185, all in relation to one another, provide application-specific damping characteristics to air spring 124 during operation of the heavy-duty vehicle.

When axle 32 of axle/suspension system 10 experiences a jounce event, such as when the heavy-duty vehicle wheels encounter a curb or a raised bump in the road, the axle moves vertically upwardly toward the chassis. In such a jounce event, bellows chamber 198 is compressed by axle/suspension system 10 as the wheels of the heavy-duty vehicle travel over the curb or the raised bump in the road. The compression of air spring bellows chamber 198 causes the internal pressure of the bellows chamber to increase, creating a pressure differential between the bellows chamber and piston chamber 199. This pressure differential causes air to flow from bellows chamber 198 through piston top plate openings 185 into piston chamber 199. The restricted flow of air between bellows chamber 198 and piston chamber 199 through piston top plate openings 185 causes damping to occur. Air continues to flow back and forth through piston top plate openings 185 until the pressures of piston chamber 199 and bellows chamber 198 have equalized.

In the event that axle 32 of axle/suspension system 10 experiences an extreme jounce event, or when air spring 124 experiences a loss of air, bellows chamber 198 undergoes extreme compression. As a result, bellows top plate 143 contacts bumper 181. Bumper 181 acts as a cushion or bump stop to limit the travel of air spring 124, preventing damage to the air spring and air spring components, such as piston 142.

When axle 32 of axle/suspension system 10 experiences a rebound event, such as when the heavy-duty vehicle wheels encounter a large hole or depression in the road, the axle moves vertically downwardly away from the chassis. In such a rebound event, bellows chamber 198 is expanded by axle/suspension system 10 as the wheels of the heavy-duty vehicle travel into the hole or depression in the road. The expansion of air spring bellows chamber 198 causes the internal pressure of the bellows chamber to decrease, creating a pressure differential between the bellows chamber and piston chamber 199. This pressure differential causes air to flow from piston chamber 199 through openings 185 into bellows chamber 198. The restricted flow of air through openings 185 causes damping to occur. Air will continue to flow back and forth through openings 185 until the pressures of piston chamber 199 and bellows chamber 198 have equalized.

Prior art air spring 124 with damping characteristics, while satisfactorily performing its intended damping function, has certain disadvantages, drawbacks, and limitations. For example, prior art air spring 124 only includes restricted airflow openings located directly between bellows chamber 198 and piston chamber 199, which limits the damping range of the air spring to a particular load, wheel motion, or narrow range of frequencies. This limitation on the damping range of air spring 124 restricts “tuning” of the damping characteristics for a given application. In particular, prior art air spring 124 typically only provides tunability over a relatively narrow frequency band, such as in the range of sprung-mass natural frequency of between 1 Hz and 2 Hz. In addition, prior art air spring 124 typically requires a relatively large air volume, which, in turn, undesirably increases the amount of space needed for incorporating the air spring into axle/suspension system 10, thereby increasing weight and reducing the available space in the heavy-duty vehicle for payload. In particular, prior art air spring 124 includes discrete bumper 181 disposed within bellows chamber 198, which prevents bellows top plate 143 from contacting piston top plate 182 during air loss and extreme jounce events. However, bumper 181 is an additional part that increases the weight of the air spring, which undesirably increases the weight of axle/suspension system 10, thereby potentially reducing the heavy-duty vehicle payload. Moreover, bumper 181 occupies additional space within bellows chamber 198, which requires either the spring rate or the bellows chamber volume V₁a to be undesirably increased to accommodate the bumper.

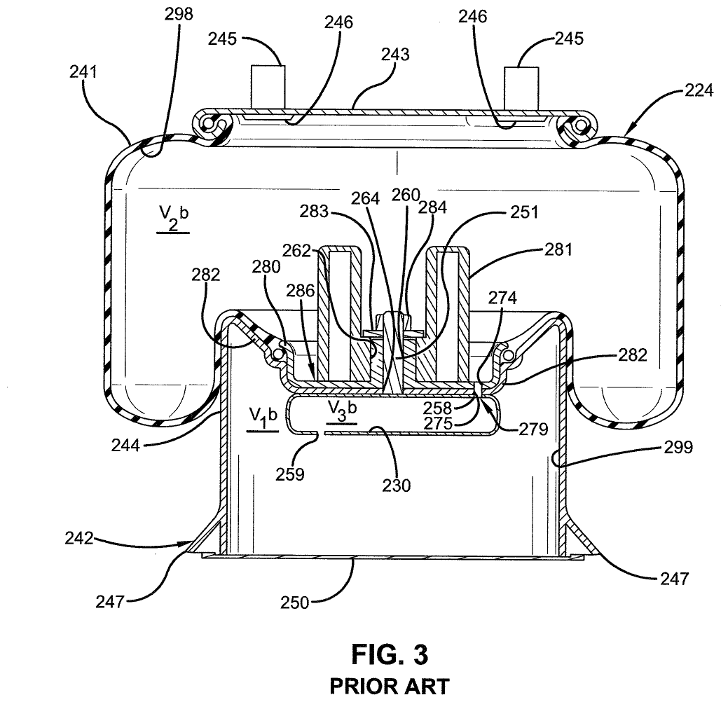

A prior art damping air spring 224 with staged openings is shown in FIG. 3. Air spring 224 may be incorporated into an axle/suspension system having a construction and arrangement similar to axle suspension system 10 or any other air-ride type axle/suspension system used with or without shock absorbers.

Air spring 224 includes a bellows 241, a bellows top plate 243, and a piston 242. Top plate 243 includes a pair of fasteners 245, each formed with an opening 246. Fasteners 245 are utilized to mount air spring 224 to an air spring mounting plate (not shown) that, in turn, is mounted to a main member (not shown) of a heavy-duty vehicle (not shown). Piston 242 is generally cylindrical-shaped and includes a sidewall 244, a bottom plate 250, a flared portion 247, and a top plate 282. Bottom plate 250, sidewall 244, and top plate 282 of piston 242 define a piston chamber 299 having an internal volume V₁b at standard static or design ride height. Bellows 241 is attached to top plate 282 by a retaining plate 286. In particular, retaining plate 286 includes a flared end 280 that is molded into the lower end of bellows 241 and holds the bellows in place on piston 242 to form an airtight seal between the bellows and the piston. Bellows 241, retaining plate 286, and bellows top plate 243 generally define a bellows chamber 298 having an internal volume V₂b at standard static or design ride height.

A bumper 281 is disposed on a top surface of retaining plate 286. Bumper 281 is formed from rubber, plastic, or other compliant material and extends generally upwardly from retaining plate 286. Bumper 281 serves as a cushion to prevent contact between piston top plate 282 and bellows top plate 243, which may cause damage during air loss or extreme jounce events during operation of the heavy-duty vehicle. Retaining plate 286, bumper 281, and piston top plate 282 are each formed with a respective opening 260, 262, and 264. A fastener 251 is disposed through piston top plate opening 264, retaining plate opening 260, and bumper opening 262. A washer 283 and a nut 284 are disposed on fastener 251 to mount bumper 281 and retaining plate 286 on the top surface of top plate 282.

An intermediate chamber 230 is operatively connected between bellows chamber 298 and piston chamber 299. Intermediate chamber 230 is generally cylindrical and includes an internal volume V₃b. Intermediate chamber 230 is formed from steel, plastic, or other material that is sufficiently rigid to maintain a constant volume in the intermediate chamber during operation of the vehicle. An opening 274 is formed in retaining plate 286 and aligns with an opening 275 formed in top plate 282 of piston 242. A further opening 258 is formed in the top wall of intermediate chamber 230 and aligns with openings 274, 275. Retaining plate opening 274, top plate opening 275, and intermediate chamber top wall opening 258 align with one another, have a generally circular-shaped horizontal cross-section, and, together, form a continuous opening 279 adjacent to bumper 281 that allows restricted fluid communication between intermediate chamber 230 and bellows chamber 298. An opening 259 is formed in the bottom wall of intermediate chamber 230. Intermediate chamber bottom wall opening 259 has a generally circular-shaped cross-section and provides restricted fluid communication between piston chamber 299 and intermediate chamber 230. Continuous opening 279 and intermediate chamber bottom wall opening 259 serve as staged openings in intermediate chamber 230. The restricted communication of air between bellows chamber 298, intermediate chamber 230, and piston chamber 299 via continuous opening 279 and intermediate chamber bottom wall opening 259 provides damping characteristics to air spring 224.

When an axle of the axle/suspension system experiences a jounce event, such as when the heavy-duty vehicle wheels encounter a curb or a raised bump in the road, the axle moves vertically upwardly toward the chassis. In such a jounce event, bellows chamber 298 of air spring 224 is compressed by the axle/suspension system as the wheels travel over the curb or the raised bump in the road. The compression of bellows chamber 298 causes the internal pressure of the bellows chamber to increase, creating a pressure differential between the bellows chamber and intermediate chamber 230. This pressure differential causes air to flow from bellows chamber 298 through continuous opening 279 into intermediate chamber 230. The flow of air into intermediate chamber 230 causes an increase in pressure in the intermediate chamber, creating a pressure differential between the intermediate chamber and piston chamber 299. This pressure differential causes air to flow from intermediate chamber 230 through intermediate chamber bottom wall opening 259 into piston chamber 299. The flow of air back and forth from bellows chamber 298 through continuous opening 279, intermediate chamber 230, and intermediate chamber bottom wall opening 259 into piston chamber 299 causes damping to occur. Air will continue to flow back and forth between bellows chamber 298 and piston chamber 299 through intermediate chamber 230 until equilibrium is reached and the pressures in the piston chamber, the intermediate chamber, and the bellows chamber have equalized.

In the event that the axle of the axle/suspension system experiences an extreme jounce event, or when air spring 224 experiences a loss of air, bellows chamber 298 undergoes extreme compression. As a result, bellows top plate 243 contacts bumper 281. Bumper 281 acts as a cushion or bump stop to limit the travel of air spring 224, preventing damage to the air spring and air spring components, such as piston 242 or retaining plate 286.

When the axle of the axle/suspension system experiences a rebound event, such as when the heavy-duty vehicle wheels encounter a large hole or depression in the road, the axle moves vertically downwardly away from the chassis. In such a rebound event, bellows chamber 298 of air spring 224 is expanded by the axle/suspension system as the wheels of the heavy-duty vehicle travel into the hole or depression in the road. The expansion of bellows chamber 298 causes the internal pressure of the bellows chamber to decrease, creating a pressure differential between the bellows chamber and intermediate chamber 230. This pressure differential causes air to flow from intermediate chamber 230 through continuous opening 279 into bellows chamber 298. Air flow from the intermediate chamber 230 causes pressure in the intermediate chamber to decrease, creating a pressure differential between the intermediate chamber and piston chamber 299. This pressure differential causes air to flow from piston chamber 299 through intermediate chamber bottom wall opening 259 into intermediate chamber 230. The flow of air back and forth from piston chamber 299 through intermediate chamber bottom wall opening 259, intermediate chamber 230, and continuous opening 279 into bellows chamber 298 causes damping to occur. Air will continue to flow back and forth between bellows chamber 298 and piston chamber 299 through intermediate chamber 230 until equilibrium is reached and the pressures in the piston chamber, the intermediate chamber, and the bellows chamber have equalized.

Prior art air spring 224 with damping characteristics, while satisfactorily performing its intended functions, has certain potential disadvantages, drawbacks, and limitations. For example, prior art air spring 224 must include discrete bumper 281 disposed within piston chamber 299 to prevent damage to intermediate chamber 230 during air loss or extreme jounce events during operation of the heavy-duty vehicle. However, because intermediate chamber 230 and bumper 281 are formed as separate components, prior art air spring 224 has an increased number of parts, which increases cost of material, manufacturing, and repair of the air spring, making it less economical, and also increasing the weight, reducing the amount of payload that can be carried by the heavy-duty vehicle. In addition, intermediate chamber 230 is disposed within piston chamber 299, which reduces the volume of the piston chamber, thereby reducing the damping performance of prior art air spring 224.

The air spring with damping characteristics of the present invention overcomes the disadvantages, drawbacks, and limitations of prior art damping air springs 124, 224 and will now be described in detail below.

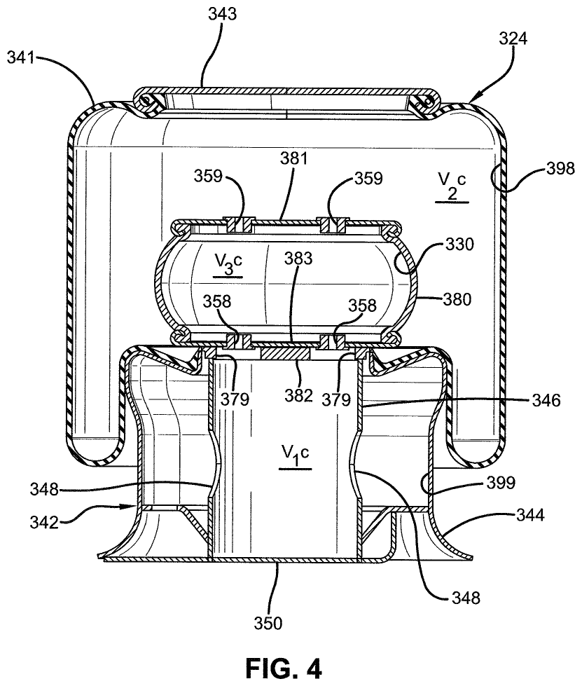

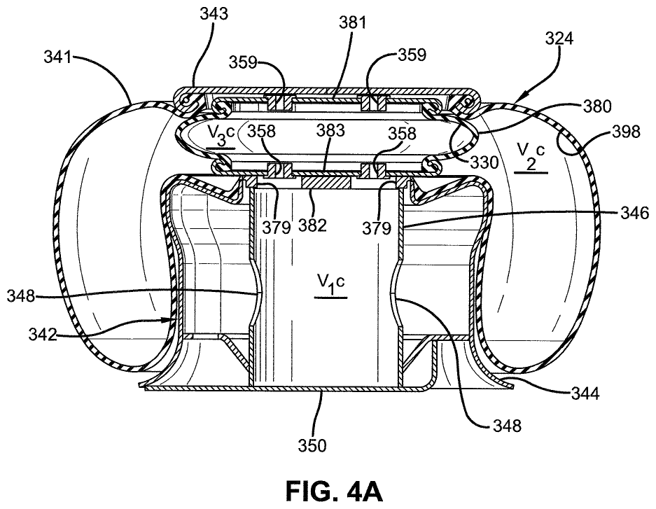

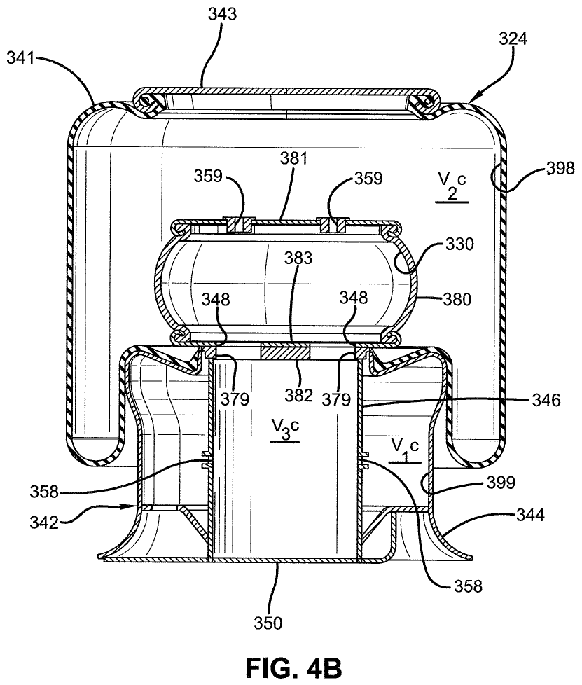

A first exemplary embodiment damping air spring 324 of the present invention is shown in FIG. 4 and will be described in detail below. Air spring 324 may be incorporated into an axle/suspension system having a construction and arrangement similar to axle/suspension system 10 or any other air-ride axle/suspension system.

Air spring 324 includes a bellows 341, a bellows top plate 343, and a piston 342. Piston 342 is generally cylindrical-shaped and includes a sidewall 344, a center support column 346, a bottom plate 350, and a top plate 382. Top plate 382, sidewall 344, and bottom plate 350 define a piston chamber 399 having an internal volume V₁c. Bellows 341, top plate 343, and piston top plate 382 define a bellows chamber 398 having an internal volume V₂c at standard static or design ride height. Center support column 346 is generally cylindrical and has one or more openings 348 such that the internal volume of the center support column is continuous with piston chamber volume V₁c. As noted above, first exemplary embodiment air spring 324 is incorporated into an axle/suspension system, such as axle/suspension system 10 described above. In such a configuration, bottom plate 350 rests on beam top plate 65 at beam rear end 26 (FIG. 1) and is attached thereto in a manner known in the art, such as by fasteners or bolts (not shown). The top end of the bellows 341 is sealingly engaged with bellows top plate 343 in a manner well known in the art. An air spring mounting plate 44, such as the one shown in FIG. 1 of the prior art, is mounted on the top surface of top plate 343 by fasteners 45, which are also used to mount the top portion of air spring 324 to a main member (not shown) of the heavy-duty vehicle. Alternatively, top plate 343 may be directly mounted to the main member of the heavy-duty vehicle, as is known.

In accordance with one of the primary features of the present invention, an intermediate chamber 330 is disposed and operatively connected between bellows chamber 398 and piston chamber 399. Intermediate chamber 330 has a generally circular-shaped horizontal cross-section and includes a sidewall 380 that extends around the circumference of the chamber. Sidewall 380 is operatively connected between an intermediate chamber top wall 381 and an intermediate chamber bottom wall 383 to define intermediate chamber 330. Bottom wall 383 is operatively connected to piston top plate 382, and the lowermost end of bellows 341 is operatively engaged with bottom wall 383 and piston sidewall 344. Intermediate chamber 330 includes an internal volume V₃c. Internal volume V₃c of intermediate chamber 330 preferably has a volume in the range of from about 70 in.³ (1147 cm³) to about 250 in.³ (4097 cm³). More specifically, internal volume V₃c of intermediate chamber 330 more preferably has a volume in the range of from about 150 in.³ (2458 cm³) to about 250 in.³ (4097 cm³).

In accordance with another primary feature of the present invention, intermediate chamber 330 is formed from plastic, rubber, or other material that is sufficiently rigid to maintain a substantially constant intermediate chamber volume V₃c during operation of the heavy-duty vehicle and sufficiently resilient to function as a bumper during air loss or extreme jounce events. In particular, intermediate chamber 330 acts as a hollow bumper, allowing a substantially constant intermediate chamber volume V₃c to be maintained during operation of the heavy-duty vehicle, thereby providing air spring 324 with a relatively larger internal volume as compared to the prior art. More particularly, intermediate chamber 330 prevents piston top plate 382 from contacting bellows top plate 343, which can potentially cause damage to the air spring 324 during air loss or extreme jounce events during operation of the heavy-duty vehicle. Moreover, because intermediate chamber sidewall 380 is sufficiently resilient, intermediate chamber 330 maintains the full travel length of air spring 324 during air loss or extreme jounce events.

In accordance with yet another primary feature of the present invention, intermediate chamber 330 includes staged openings to provide restricted fluid communication between bellows chamber 398, the intermediate chamber, and piston chamber 399. In particular, a pair of openings 358 are formed in the bottom wall 383 and are continuous with, and in fluid communication with, a passage 379 in top plate 382 of piston 342. Continuous openings 358 provide fluid communication between piston chamber 399 and intermediate chamber 330. Another pair of openings 359 are formed in top wall 381 of intermediate chamber 330. Intermediate chamber top wall openings 359 provide fluid communication between bellows chamber 398 and intermediate chamber 330. Openings 358, 359 may be formed at any location relative to the piston top plate 382 and in intermediate top wall 381, respectively. Openings 358, 359 have a generally circular-shaped horizontal cross-section, but may have any other suitable shape, such as oval, elliptical, or polygonal. Openings 358, 359 preferably have an area in the range of from about 0.039 in² (0.25 cm²) to about 0.13 in² (0.84 cm²).

Intermediate chamber 330 provides air spring 324 with improved air flow control between bellows chamber 398 and piston chamber 399, optimizing the damping characteristics of the air spring. In particular, the restricted communication of air between bellows chamber 398, intermediate chamber 330, and piston chamber 399 via continuous openings 358 and intermediate chamber top wall openings 359 provides damping characteristics to air spring 324. The staged arrangement of openings 358, 359 allow the damping characteristics of air spring 324 to be tuned for different applications over a broader range of frequencies. For example, the sizes of openings 358, 359 may be chosen to provide damping for a given load at the primary ride frequency, typically about 1 Hz to about 2 Hz, in combination with the intermediate chamber volume V₃c that provides damping for the load at a secondary wheel hop frequency, typically about 8 Hz to about 12 Hz.

When the axle of the axle/suspension system experiences a jounce event, such as when the heavy-duty vehicle wheels encounter a curb or raised bump in the road, the axle moves vertically upwardly toward the chassis. In such a jounce event, bellows chamber 398 is compressed by the axle/suspension system as the wheels of the heavy-duty vehicle travel over the curb or the raised bump in the road. The compression of air spring bellows chamber 398 causes the internal pressure of the bellows chamber to increase, creating a pressure differential between the bellows chamber and intermediate chamber 330. This pressure differential causes air to flow from bellows chamber 398 through intermediate chamber top wall openings 359 into intermediate chamber 330. The flow of air into intermediate chamber 330 causes the internal pressure within the intermediate chamber to increase, creating a pressure differential between the intermediate chamber and piston chamber 399. This pressure differential causes air to flow from intermediate chamber 330 through continuous openings 358 into piston chamber 399. The flow of air back and forth from bellows chamber 398 through intermediate chamber top wall openings 359, intermediate chamber 330, and continuous openings 358 into piston chamber 399 causes damping to occur. Air will continue to flow back and forth between bellows chamber 398 and piston chamber 399 through intermediate chamber 330 until equilibrium is reached and the pressures in the piston chamber, the intermediate chamber, and the bellows chamber have equalized.

In the event that the axle of the axle/suspension system experiences an extreme jounce event, or when air spring 324 experiences a loss of air, bellows chamber 398 undergoes extreme compression, as shown in FIG. 4A. As a result, bellows top plate 343 contacts top wall 381 of intermediate chamber 330. Intermediate chamber 330 acts as a cushion or bump stop and may be substantially compressed, preventing damage to air spring 324 and air spring components, such as piston 342.

When the axle of the axle/suspension system experiences a rebound event, such as when the heavy-duty vehicle wheels encounter a large hole or depression in the road, the axle moves vertically downwardly away from the chassis. In such a rebound event, bellows chamber 398 is expanded by the axle/suspension system as the wheels of the heavy-duty vehicle travel into the hole or depression in the road. The expansion of bellows chamber 398 causes the internal pressure of the bellows chamber to decrease, creating a pressure differential between the bellows chamber and intermediate chamber 330. This pressure differential causes air to flow from intermediate chamber 330 through intermediate chamber top wall openings 359 into bellows chamber 398. The flow of air from intermediate chamber 330 causes the internal pressure within the intermediate chamber to decrease, creating a pressure differential between the intermediate chamber and piston chamber 399. This pressure differential causes air to flow from piston chamber 399 through continuous openings 358 into intermediate chamber 330. The flow of air back and forth from piston chamber 399 through continuous openings 358, intermediate chamber 330, and intermediate chamber top wall openings 359 into bellows chamber 398 causes damping to occur. Air will continue to flow back and forth between bellows chamber 398 and piston chamber 399 through intermediate chamber 330 until equilibrium is reached and the pressures in the piston chamber, the intermediate chamber, and the bellows chamber have equalized.

With additional reference to FIG. 4B, the first exemplary embodiment air spring of the present invention may have an alternate configuration. In particular, a pair of openings 348 may be formed in bottom wall 383 to provide generally unrestricted fluid communication between center support column 346 and intermediate chamber 330, such that the internal volume of the center support column is continuous with intermediate chamber volume V₃c. In addition, center support column 346 may include one or more openings 358 to provide fluid communication between intermediate chamber volume V₃c and piston chamber volume V₁c. As above, the restricted fluid communication of openings 358, 359 provide air spring 324 with damping.

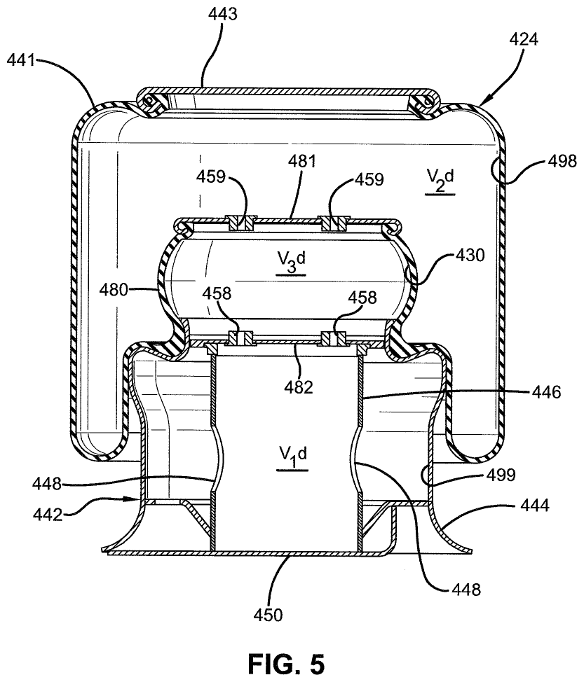

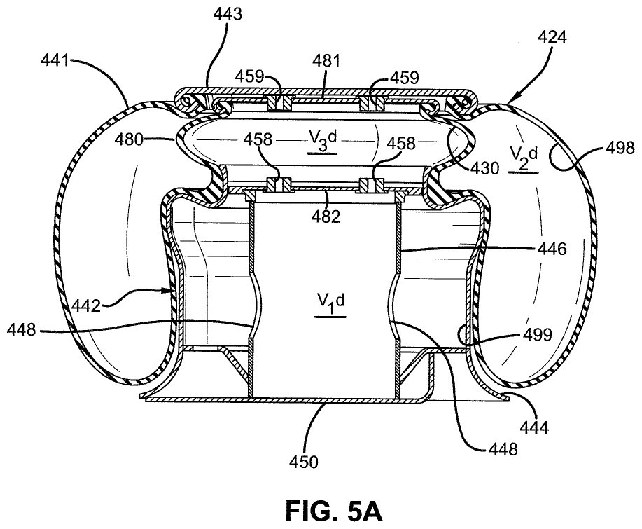

A second exemplary embodiment damping air spring 424 with staged openings of the present invention is shown in FIG. 5 and will be described in detail below. Damping air spring 424 is similar in construction and arrangement to damping air spring 324 and, likewise, may be incorporated into an axle/suspension system similar to axle/suspension system 10 or any other air-ride axle/suspension system. As a result, the description below is directed to the differences between air spring 424, illustrated in FIGS. 5 and 5B, and air spring 324 as illustrated in FIG. 4.

Air spring 424 includes a bellows 441, a bellows top plate 443, and a piston 442. Piston 442 is generally cylindrical-shaped and includes a sidewall 444, a center support column 446, a bottom plate 450, and a top plate 482. Bottom plate 450 rests on a beam of a suspension assembly (not shown) and is attached thereto in a known manner, such as by fasteners or bolts (not shown). Top plate 482, sidewall 444, and bottom plate 450 define a piston chamber 499 having an internal volume V₁d at standard static or design ride height. Center support column 446 is generally cylindrical and has one or more openings 448, such that the internal volume of the center support column is continuous with piston chamber volume V₁d. The top end of the bellows 441 is sealingly engaged with bellows top plate 443 in a manner well known in the art. An air spring mounting plate (not shown) is mounted on the top surface of top plate 443 by fasteners (not shown) which are also used to mount the top portion of air spring 424 to a main member (not shown) of the heavy-duty vehicle (not shown). Alternatively, top plate 443 may be directly mounted to the main member, as is known. Bellows 441, top plate 443, and piston top plate 482 define a bellows chamber 498 having an internal volume V₂d at standard static or design ride height.

In accordance with one of the primary features of the present invention, an intermediate chamber 430 is disposed between and operatively connected to bellows chamber 498 and piston chamber 499. Intermediate chamber 430 has a generally circular horizontal cross-section and includes an intermediate chamber top wall 481 and a sidewall 480, which extends around the circumference of the intermediate chamber and is integrally formed and continuous with bellows 441. Sidewall 480 is connected to intermediate top wall 481 and, together with the intermediate top wall and piston top plate 482, defines intermediate chamber 430. Intermediate chamber 430 includes an internal volume V₃d. Internal volume V₃d is preferably in the range of from about 70 in³ (1147 cm³) to about 250 in³ (4097 cm³). More specifically, internal volume V₃d is more preferably in the range of from about 150 in³ (2458 cm³) to about 250 in³ (4097 cm³).

In accordance with another primary feature of the present invention, intermediate chamber 430 acts as a bumper and serves as a cushion to prevent contact between piston top plate 482 and bellows top plate 443, which can potentially cause damage to the plates and air spring 424 during air loss or extreme jounce events during operation of the heavy-duty vehicle. In particular, sidewall 480 of intermediate chamber 430 is formed continuously with, and from the same material as, bellows 441 but may be treated or have additional layers or internal reinforcement, such that the intermediate chamber is sufficiently rigid to maintain a constant internal volume V₃d during normal operation of the heavy-duty vehicle. In addition, sidewall 480 has sufficient resilience to act as a bumper and collapse, as shown in FIG. 5A, to maintain the full travel of air spring 424 during air loss or extreme jounce events. More particularly, because intermediate chamber 430 acts as a hollow bumper, a substantially constant intermediate chamber volume V₃d is maintained during normal operation of the heavy-duty vehicle, providing air spring 424 with a relatively larger internal volume than the prior art.

In accordance with yet another primary feature of the present invention, intermediate chamber 430 includes staged openings to provide restricted fluid communication between bellows chamber 498, the intermediate chamber, and piston chamber 499. In particular, a pair of openings 458 are formed in piston top plate 482 of piston 442. Piston top plate openings 458 provide fluid communication between piston chamber 499 and intermediate chamber 430. Another pair of openings 459 are formed in top wall 481 of intermediate chamber 430. Intermediate chamber top wall openings 459 provide fluid communication between bellows chamber 498 and intermediate chamber 430. Openings 458, 459 may be formed at any location on the piston top plate 482 and intermediate top wall 481, respectively. Openings 458, 459 have a generally circular-shaped horizontal cross-section, but may have any other suitable shape, such as oval, elliptical, or polygonal. Openings 458, 459 preferably have an area in the range of from about 0.039 in² (0.25 cm²) to about 0.13 in² (0.84 cm²).

Intermediate chamber 430 provides air spring 424 with improved air flow control between bellows chamber 498 and piston chamber 499, optimizing the damping characteristics of the air spring. The restricted communication of air between bellows chamber 498, intermediate chamber 430, and piston chamber 499 via piston top plate openings 458 and intermediate chamber top wall openings 459 provides damping characteristics to air spring 424. The staged arrangement of openings 458, 459 allow the damping characteristics of air spring 424 to be tuned for different applications over a broader range of frequencies. For example, the sizes of openings 458, 459 may be chosen to provide damping for a given load at the primary ride frequency, typically about 1 Hz to about 2 Hz, in combination with the intermediate chamber volume V₃d that provides damping for the load at a secondary wheel hop frequency, typically about 8 Hz to about 12 Hz.

Thus, first and second exemplary embodiment damping air springs 324, 424 overcome the problems associated with prior art air springs 124, 224 by providing damping features to the axle/suspension system over a broader damping range without reducing air spring travel height in order to accommodate a broader range of loads and wheel motions, thereby reducing the constraints on the operating range of the damping air spring. In addition, first and second exemplary embodiment damping air springs 324, 424 reduce or eliminate frequency dependence and eliminate the need for a bumper separate from intermediate chamber 330, 430, respectively, reducing the need for larger air volumes to increase damping characteristics, which, in turn, reduces the amount of space required by the axle/suspension system and allows for increased space and reduced weight of the axle/suspension system so that additional payload can be carried by the heavy-duty vehicle. Moreover, elimination of the separate bumper reduces the number of parts utilized by first and second exemplary embodiment air springs 324, 424, which reduces the cost of materials, manufacturing, and repair of the air springs. Flexible intermediate chamber 330, 430 serves as a bumper and is capable of collapse during extreme compression of air spring 324, 424, thereby maintaining air spring travel height, while also maintaining a substantially fixed or constant volume during normal operation of the heavy-duty vehicle when no extreme jounce events occur.

It is contemplated that the concepts shown in first and second exemplary embodiment air springs 324, 424 could be utilized in any type of air spring utilized in conjunction with heavy-duty vehicles without changing the overall concept or operation of the present invention. It is also contemplated that first and second exemplary embodiment air springs 324, 424 could be utilized on heavy-duty vehicles having one or more than one axle without changing the overall concept or operation of the present invention. It is further contemplated that first and second exemplary embodiment air springs 324, 424 could be utilized on heavy-duty vehicles having frames or subframes which are moveable or non-movable without changing the overall concept or operation of the present invention. It is yet even further contemplated that first and second exemplary embodiment air springs 324, 424 could be utilized on all types of air-ride leading- or trailing-arm beam-type axle/suspension systems, axle/suspension systems having overslung/top-mount or underslung/bottom-mount configurations, or other types of air-ride rigid beam-type axle/suspension systems, such as those using U-bolts, U-bolt brackets/axle seats, and the like, known to those skilled in the art, without changing the overall concept or operation of the present invention. It is further contemplated that first and second exemplary embodiment air springs 324, 424 could be formed from various materials, including metal, composites, and the like, without changing the overall concept or operation of the present invention. It is even contemplated that first and second exemplary embodiment air springs 324, 424 could be utilized in combination with prior art shock absorbers and/or other similar devices without changing the overall concept or operation of the present invention.

It is contemplated that any number of openings 358, 458 and 359, 459, from a single opening to multiple openings, may be formed in intermediate chamber bottom wall 383 or piston top plate 382, 482 and in intermediate chamber top wall 381, 481, respectively, without changing the overall concept or operation of the present invention. It is also contemplated that intermediate chamber top wall openings 359, 459 of the present invention could be formed anywhere relative to continuous openings 358 and piston top plate openings 458 and may also be formed anywhere on intermediate chamber sidewall 380, 480 without changing the overall concept or operation of the present invention.

Accordingly, the air spring of the present invention is simplified, provides an effective, safe, inexpensive, and efficient structure and method, which achieves all the enumerated objectives, provides for eliminating difficulties encountered with prior air springs, and solves problems and obtains new results in the art.

In the foregoing description, certain terms have been used for brevity, clarity, and understanding, but no unnecessary limitations are to be implied therefrom beyond the requirements of the prior art because such terms are used for descriptive purposes and are intended to be broadly construed.

The present invention has been described with reference to specific embodiments. It is to be understood that this illustration and description is by way of example and not by way of limitation. Potential modifications and alterations will occur to others upon a reading and understanding of this disclosure, and it is understood that the invention includes all such modifications, alterations, and equivalents thereof.

Having now described the features, discoveries, and principles of the invention; the manner in which the air spring of the present invention is used and installed; the characteristics of the construction, arrangement, and method steps; and the advantageous, new, and useful results obtained; the new and useful structures, devices, elements, arrangements, process, parts, and combinations are set forth in the appended claims.

What is claimed is:

1. An air spring with damping characteristics for a suspension assembly of a heavy-duty vehicle comprising:
a bellows chamber;
a piston chamber;
an intermediate chamber operatively connected to said bellows chamber and said piston chamber, said intermediate chamber being disposed at least partially within said bellows chamber;
a first means for providing restricted fluid communication between the bellows chamber and the intermediate chamber; and
a second means for providing restricted fluid communication between the piston chamber and said intermediate chamber, wherein said first and second means for providing restricted fluid communication provide damping characteristics to said air spring during operation of said heavy-duty vehicle.

2. The air spring with damping characteristics of claim 1, said intermediate chamber being adjacent said piston chamber.

3. The air spring with damping characteristics of claim 1, said bellows being formed continuously with said intermediate chamber.

4. The air spring with damping characteristics of claim 3, said bellows being at least partially inverted for attachment to said piston.

5. The air spring with damping characteristics of claim 1, said intermediate chamber being a bumper preventing contact during operation of the vehicle between a bellows top plate forming a part of said bellows chamber and a piston top plate forming a part of said piston chamber.

6. The air spring with damping characteristics of claim 5, said intermediate chamber being sufficiently rigid to maintain a constant volume in the intermediate chamber during normal operation of the vehicle.

7. The air spring with damping characteristics of claim 6, said intermediate chamber being flexible to allow collapse of the intermediate chamber during extreme jounce events.

8. The air spring with damping characteristics of claim 1, said bellows chamber having a volume of from about 305 in.³ to about 915 in.³.

9. The air spring with damping characteristics of claim 8, said piston chamber having a volume of from about 150 in.³ to about 550 in.³.

10. The air spring with damping characteristics of claim 9, said intermediate chamber having a volume of from about 70 in.³ to about 250 in.³.

11. The air spring with damping characteristics of claim 9, said intermediate chamber having a volume of from about 150 in.³ to about 250 in.³.

12. The air spring with damping characteristics of claim 1, said first means for providing restricted fluid communication further comprising a first opening;
said second means for providing restricted fluid communication further comprising a second opening.

13. The air spring with damping characteristics of claim 12, said first opening and said second opening being staged vertically from one another.

14. The air spring with damping characteristics of claim 12, said first opening having a diameter of from about 0.25 cm to about 0.84 cm.

15. The air spring with damping characteristics of claim 12, said second opening having a diameter of from about 0.25 cm to about 0.84 cm.

16. The air spring with damping characteristics of claim 12, said first and second opening having a diameter of from about 0.25 cm to about 0.84 cm.

17. The air spring with damping characteristics of claim 12, said first opening including a horizontal cross section comprising a shape chosen from the group consisting of a circle, an oval, an ellipse and a polygon.

18. The air spring with damping characteristics of claim 12, said second opening including a horizontal cross section comprising a shape chosen from the group consisting of a circle, an oval, an ellipse and a polygon.

19. The air spring with damping characteristics of claim 12, said first and second opening including a horizontal cross section comprising a shape chosen from the group consisting of a circle, an oval, an ellipse and a polygon.
